(19) United States
(12) Patent Application Publication
(10) Pub. No.: US 2026/0160638 A1
(43) Pub. Date: Jun. 11, 2026

(54) Automated Interleaved Optical Module Testing method

(71) Applicant: Shenzhen Haixun Guangtong Intelligent Equipment Co., Ltd., Guangming Shenzhen (CN)

(72) Inventors: Weichuan ZHANG, Guangming Shenzhen (CN); Jianyi XIA, Guangming Shenzhen (CN); Zongquan DONG, Guangming Shenzhen (CN); Siwei LI, Guangming Shenzhen (CN); Chunjia WANG, Guangming Shenzhen (CN)

(21) Appl. No.: 19/465,310

(22) Filed: Jan. 30, 2026

(30) Foreign Application Priority Data
Nov. 29, 2024 (CN) 2024229535884
Nov. 29, 2024 (CN) 2024229619131
Nov. 29, 2024 (CN) 2024229729273
Apr. 24, 2025 (CN) 2025207948418
Jun. 18, 2025 (CN) 2025212588889
Jun. 18, 2025 (CN) 2025212618051
Nov. 19, 2025 (WO) PCT/CN2025/135956

(51) Int. Cl. G01M 11/00; G02B 27/00

(52) U.S. Cl. CPC G01M 11/30; G02B 27/0006

(57) ABSTRACT

An automated interleaved optical module testing method is provided, wherein the automated interleaved optical module testing method interleaves the testing process of at least two optical modules to improve the testing efficiency of optical modules, and can be automated based on machines to reduce errors and labor costs of manual operation.

### CROSS REFERENCE OF RELATED APPLICATION

This is a Continuation Application of PCT/CN2025/135956 filed Nov. 19, 2025, which claims priority under 35 U.S.C. 119(a-d) to Chinese application numbers 202422972927.3, filed Nov. 29, 2024,202422953588.4,filed Nov. 29, 2024, 202422961913.1,filed Nov. 29,2024, 202520794841.8, filed Apr. 24, 2025, 202521261805.1, filed Jun. 18, 2025, and 202521258888.9, filed Jun. 18, 2025 the afore-mentioned patent applications are hereby incorporated by reference in their entireties.

### BACKGROUND OF THE PRESENT INVENTION

### Field of Invention

The present invention relates to the field of optical module testing, and in particular to an automated interleaved optical module testing method.

### Description of Related Arts

An optical module is an optoelectronic component for performing optical-electrical and electrical-optical conversion. A transmitting end of the optical module converts an electrical signal into an optical signal which is transmitted through an optical fiber connector, and then a receiving end converts the optical signal back into an electrical signal. The optical module is a core component of an optical communication network, and its performance directly determines the transmission rate and stability of an optical communication link. In order to ensure that optical modules leaving the factory meet corresponding performance standards, each optical module must undergo a series of rigorous tests before shipment.

Conventional optical module testing methods mainly rely on manually inserting the test module into the optical module to perform performance testing, that is, a test operator manually operates testing instruments step by step to complete the testing process for a single optical module.

Under this testing method, the optical module and the test module are manually plugged and unplugged during mating, and the applied force is difficult to control precisely. In addition, the accuracy of manual insertion and removal is affected by the operator's subjective skill level. If the insertion and removal force and accuracy are not precisely controlled, damage to the optical module or the test module is likely to occur, resulting in significant human error. Meanwhile, since the operating methods of test operators are subjectively different, variations in operating habits and experience among different operators lead to non-standardized testing processes, making it difficult to ensure the consistency of test results and thus the consistency of product quality. Furthermore, the testing steps for optical modules are repetitive, causing operator fatigue and increasing the risk of errors. Moreover, because optical module testing involves many test programs and different test programs or testing instruments are relatively independent, a single test operator can only operate or monitor one instrument to perform one testing procedure at a time, resulting in low testing efficiency and an inability to meet the requirements of mass production. Consequently, conventional optical module manufacturers can only increase testing capacity by investing a large amount of manpower, leading to persistently high labor costs.

### SUMMARY OF THE PRESENT INVENTION

An object of the present invention is to provide an automated interleaved optical module testing method, wherein the automated interleaved optical module testing method is based on machine-automated execution of optical module testing, so as to reduce errors from manual operation and ensure the consistency of batch test results.

Another object of the present invention is to provide an automated interleaved optical module testing method, wherein the automated interleaved optical module testing method automates the optical module testing process, so that it is beneficial to reduce labor costs.

Another object of the present invention is to provide an automated interleaved optical module testing method, wherein the automated interleaved optical module testing method can improve the testing efficiency of optical modules and realize batch testing of optical modules.

Another object of the present invention is to provide an automated interleaved optical module testing method, wherein the automated interleaved optical module testing method interleaves the testing process of at least two optical modules, so as to shorten the overall testing time and improve testing efficiency.

Another object of the present invention is to provide an automated interleaved optical module testing method, wherein the automated interleaved optical module testing method automatically interleaves the testing process of the optical module, reduces labor costs and human error while improving testing efficiency, and has significant commercial value.

Another object of the present invention is to provide an automated interleaved optical module testing method, wherein the automated interleaved optical module testing method interleavedly executes the testing processes of at least two optical modules, that is, the start of the testing process of the next optical module does not need to wait for the end of the testing process of the previous optical module, and the testing processes of at least two optical modules can be performed in parallel at the same time, thereby improving testing efficiency.

Another object of the present invention is to provide an automated interleaved optical module testing method, wherein the automated interleaved optical module testing method is based on interleaved testing of optical modules, so as to effectively reduce the idle time of testing equipment and improve resource utilization.

Another object of the present invention is to provide an automated interleaved optical module testing method, wherein the automated interleaved optical module testing method is based on interleaved testing of optical modules, enabling corresponding testing equipment to take turns testing optical modules, thereby improving the efficiency of batch testing while avoiding resource conflicts.

Another object of the present invention is to provide an automated interleaved optical module testing method, wherein the automated interleaved optical module testing method is based on interleaved testing of optical modules, so that at the same time, one test station can execute the testing process of at least two optical modules, effectively improving the test throughput.

Another object of the present invention is to provide an automated interleaved optical module testing method, wherein the automated interleaved optical module testing method improves the transfer efficiency of the robotic arm to optical modules by picking up at least two optical modules with different testing progress at the same time, thereby improving the efficiency of interleaved optical module testing.

Another object of the present invention is to provide an automated, interleaved optical module testing method, wherein the robotic arm comprises a robotic arm body and a robotic hand disposed at the end of the robotic arm body, wherein the robotic hand comprises at least two picking elements, wherein the picking elements are used to pick up optical modules, and wherein the robotic hand is capable of picking up two optical modules at different testing stages at the same time, thereby improving the transfer efficiency of the robotic arm for the optical modules.

Another object of the present invention is to provide an automated interleaved optical module testing method, wherein the automated interleaved optical module testing method sorts optical modules based on their test results, facilitating rapid identification and processing of optical modules with different test results, improving work efficiency, and enabling subsequent analysis of optical modules with unqualified test results. This provides feedback for production and allows for targeted improvement measures, ultimately enhancing the product quality of optical modules.

Another object of the present invention is to provide an automated interleaved optical module testing method, wherein the automated interleaved optical module testing method can automatically process unqualified optical modules during the testing process and re-execute the testing process of the next optical module, so as to continuously perform optical module testing without human intervention.

Another object of the present invention is to provide an automated interleaved optical module testing method, wherein the automated interleaved optical module testing method can automatically sort and unload unqualified optical modules in different test programs, so as to facilitate subsequent targeted analysis of optical modules that are NG in different test programs, which is beneficial to take targeted measures to improve the yield and product quality of the optical modules.

Another object of the present invention is to provide an automated interleaved optical module testing method, wherein the automated interleaved optical module testing method cleans the fiber optic connector before plugging it into the optical module to remove dust, impurities, and other contaminants that may be present in the fiber optic connector, thereby avoiding contaminants from affecting the test results and damaging the optical module.

Another object of the present invention is to provide an automated interleaved optical module testing method, wherein the automated interleaved optical module testing method identifies each optical module to facilitate subsequent analysis and tracing.

According to an aspect of the present invention, the present invention provides an automated interleaved optical module testing method, wherein the automated interleaved optical module testing method comprises the following steps:
(A) picking up a first optical module by a robotic arm;
(B) placing the first optical module on an end-face inspection instrument by the robotic arm, and performing an end-face inspection on the first optical module by the end-face inspection instrument;
(C) pulling out a second optical module that has completed the test from a testing instrument by the robotic arm, placing the second optical module in a fiber optic plug-in station, and picking up the second optical module after a fiber optic connector on the second optical module is pulled out;
(D) placing the first optical module in the fiber optic plug-in station by the robotic arm, and plugging the first optical module into the testing instrument after the fiber optic connector is plugged into the first optical module;
(E) placing the second optical module in an unloading area by the robotic arm, and returning to the step (A).

According to an embodiment, wherein in the step (A), after the robotic arm picks up the first optical module, the first optical module is moved to a barcode scanning station, and after the first optical module is identified at the barcode scanning station, the step (B) is executed.

According to an embodiment, wherein in the step (B), if the test result is qualified, the step (C) is executed; if the test result is unqualified, the robotic arm moves the first optical module to the unloading area and returns to the step (A).

According to an embodiment, wherein if the End-face inspection is qualified, the robotic arm picks up the first optical module, and the step (C) is executed while the robotic arm is picking up the first optical module.

According to an embodiment, wherein if the end-face inspection is qualified and before performing the step (D), the robotic arm picks up the first optical module and places the first optical module in a preheating station.

According to an embodiment, wherein in the step (D), the fiber optic plug-in station cleans the fiber optic connector before plugging the fiber optic connector into the first optical module.

According to an embodiment, wherein in the step (D), before plugging the first optical module into the testing instrument, the robotic arm moves the first optical module to the barcode scanning station, and after the first optical module is identified at the barcode scanning station, the first optical module is plugged into the testing instrument.

According to an embodiment, wherein in the step (C), before the fiber optic connector is pulled out of the second optical module, the fiber optic plug-in station retains and fixes the second optical module.

According to an embodiment, wherein in the step (D), before inserting the fiber optic connector into the first optical module, the fiber optic plug-in station limits and fixes the first optical module.

According to an embodiment, wherein in the step (E), the robotic arm places the second optical module in different areas of the unloading area based on the test results of the second optical module.

According to an embodiment, wherein the robotic arm comprises a robotic arm body and a robotic hand disposed at an end of the robotic arm body, wherein the robotic hand comprises at least two picking elements for picking up the optical modules, wherein in the step (D), one of the picking elements of the robotic hand picks up the second optical module, and the other picking member of the robotic hand picks up the first optical module.

According to an embodiment, wherein the robotic hand comprises a base and a vision positioning sensor, wherein the base is connected to the end of the robotic arm body, and the vision positioning sensor and each of the picking elements are respectively mounted on different sides of the base.

According to an embodiment, wherein the robotic arm comprises two different types of picking elements, one of which is a suction claw and the other is a gripping claw, wherein the suction claw comprises a first lifting element and a pair of suction cups, wherein the first lifting element is mounted on the base, wherein each suction cup is mounted on the first lifting element and adapted to be driven by the first lifting element to move up and down with respect to the base, wherein the gripping claw comprises a second lifting element and a gripper, wherein the second lifting element is mounted on the base, the gripper is mounted on the second lifting element and adapted to be driven by the second lifting element to move up and down with respect to the base, and the gripper comprises a pair of gripping fingers.

According to an embodiment, wherein the robotic arm comprises two said gripping claws, and the two gripping claws are of the same type.

According to an embodiment, wherein the robotic arm comprises two said gripping claws, wherein the opening and closing range of the two gripping fingers of one gripping claw is smaller than the opening and closing range of the two gripping fingers of the other gripping claw.

According to an embodiment, wherein the robotic arm comprises a six-dimensional force sensor, wherein the six-dimensional force sensor is disposed between the base and the end of the robotic arm body, wherein a bottom of the base is provided with a suction component for suctioning a corresponding tray which is arranged for placing the optical module.

According to an embodiment, wherein the fiber optic plug-in station comprises an optical module mounting base, a cleaning unit, and a fiber optic plug-in socket, wherein the optical module mounting base and the fiber optic plug-in socket are arranged along a plugging direction of the fiber optic connector, the optical module mounting base is vertically movable, the fiber optic plug-in socket is movable along the plugging direction of the fiber optic connector, the cleaning unit is vertically movable between the optical module mounting base and the fiber optic plug-in socket, wherein the robotic arm places the optical module in the fiber optic plug-in station with the optical module mounted on the optical module mounting base, wherein the cleaning unit rises between the optical module mounting base and the fiber optic plug-in socket before the fiber optic connector is plugged into the optical module, the fiber optic plug-in socket moves the fiber optic connector toward the cleaning unit so that the fiber optic connector contacts the cleaning unit and is cleaned, and after cleaning, the fiber optic plug-in socket moves away from the cleaning unit, and the cleaning unit descends.

According to an embodiment, wherein the optical module mounting base comprises a lifting component, a lifting seat, a clamping seat, and a pressing part, wherein the lifting seat is installed on the lifting component and is adapted to be driven to rise or fall by the lifting component, wherein the clamping seat is disposed on the lifting seat and comprises two opposing retaining walls, the robotic arm places the optical module in the fiber optic plug-in station with the optical module placed between the two retaining walls, the distance between the two retaining walls is adjustable for clamping the optical module, wherein the pressing part comprises a rotary lifting seat and a pressing rod, wherein a bottom of the rotary lifting seat is installed on the lifting seat, a top of the rotary lifting seat comprises an upwardly extending rotary telescopic rod, wherein the pressing rod is connected to the rotary telescopic rod and has an extension direction perpendicular to an axial direction of the rotary telescopic rod.

According to an embodiment, wherein the fiber optic plug-in socket comprises a longitudinal moving base, a transverse moving base, a transverse clamping component, and a lifting unlocking component, wherein the transverse moving base is mounted on the longitudinal moving base and moves along the plugging direction of the fiber optic connector following the longitudinal moving base, wherein the transverse clamping component is mounted on the transverse moving base and comprises two clamping arms opposite each other in the transverse direction, a distance between the two clamping arms is adjustable to clamp the fiber optic connector, wherein the lifting unlocking component is vertically movably mounted on the transverse moving base and is used to press down the fiber optic connector clamped between the two clamping arms, so as to allow the fiber optic connector to be plugged into the optical module.

According to an embodiment, wherein the unloading area comprises an end-face inspection NG tray, a test NG tray, and a finished product tray, wherein the end-face inspection NG tray is used to place optical modules that fail the end-face inspection, the test NG tray is used to place optical modules that fail the test by the testing instrument, and the finished product tray is used to place optical modules that pass the test, wherein in the step (B), if the end-face inspection result is unqualified, the robotic arm places the optical module in the end-face inspection NG tray, wherein in the step (E), based on the test result of the testing instrument, the robotic arm places the optical module in the test NG tray or the finished product tray, wherein in the step (A), the robotic arm picks up the optical module from a raw material tray, wherein the raw material tray is used to store the optical module waiting to be tested, wherein the unloading area further comprises a spare tray, wherein the spare tray is used to be activated as such when one of the end-face inspection NG tray, the test NG tray, and the finished product tray is full of the optical module.

The further objects and advantages of the invention will become fully apparent from the following description and accompanying drawings.

### BRIEF DESCRIPTION OF THE DRAWINGS

FIG. 1 is a schematic diagram illustrating the progress of optical module testing within a time period of an automated interleaved optical module testing method according to an embodiment of the present invention.

FIG. 2 is a flowchart illustrating the steps of the automated interleaved optical module testing method according to the above embodiment of the present invention.

FIG. 3 is a schematic view of an optical module test platform for performing the automated interleaved optical module testing method according to the above embodiment of the present invention.

FIG. 4 is a schematic view illustrating the structure of the robotic arm of the optical module test platform according to the above embodiment of the present invention.

FIG. 5 is a schematic view illustrating the structure of the robotic hand of the robotic arm of the optical module test platform according to the above embodiment of the present invention.

FIG. 6 is a schematic view illustrating the robotic hand of the robotic arm of the optical module test platform from another perspective according to the above embodiment of the present invention.

FIG. 7 is a schematic view illustrating the plug-in station of the optical module test platform according to the above embodiment of the present invention.

FIG. 8 is a partial structural schematic view illustrating the plug-in station of the optical module test platform according to the above embodiment of the present invention.

FIG. 9 is another partial structural schematic view illustrating the plug-in station of the optical module test platform according to the above embodiment of the present invention.

FIG. 10 is a partial structural schematic view illustrating the fiber optic plug-in socket of the plug-in station of the optical module test platform according to the above embodiment of the present invention.

### DETAILED DESCRIPTION OF THE PREFERRED EMBODIMENT

The following description is intended to disclose the present invention and enable those skilled in the art to implement it. The preferred embodiments described below are merely examples, and other obvious variations will occur to those skilled in the art. The basic principles of the invention defined in the following description can be applied to other embodiments, modifications, improvements, equivalents, and other technical solutions that do not depart from the spirit and scope of the invention.

Those skilled in the art should understand that, in the disclosure of the present invention, the terms “longitudinal”, “lateral”, “upper”, “lower”, “front”, “rear”, “left”, “right”, “vertical”, “horizontal”, “top”, “bottom”, “inner”, and “outer” etc., indicate the orientation or positional relationship based on the orientation or positional relationship shown in the accompanying drawings. They are only for the convenience of describing this invention and simplifying the description, and do not indicate or imply that the device or element referred to must have a specific orientation, or be constructed and operated in a specific orientation. Therefore, the above terms should not be construed as limiting this invention.

It is understood that the term “a” or “an” should be understood as “at least one” or “one or more”, that is, in one embodiment, the number of an element can be one, while in another embodiment, the number of the element can be multiple, and the term “a” or “an” should not be understood as a limitation on the number.

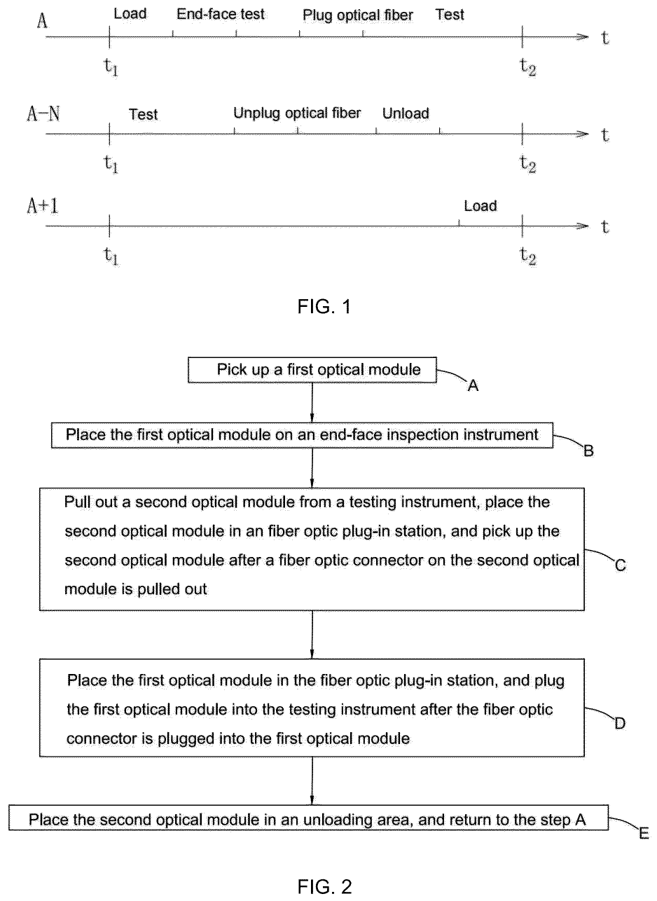

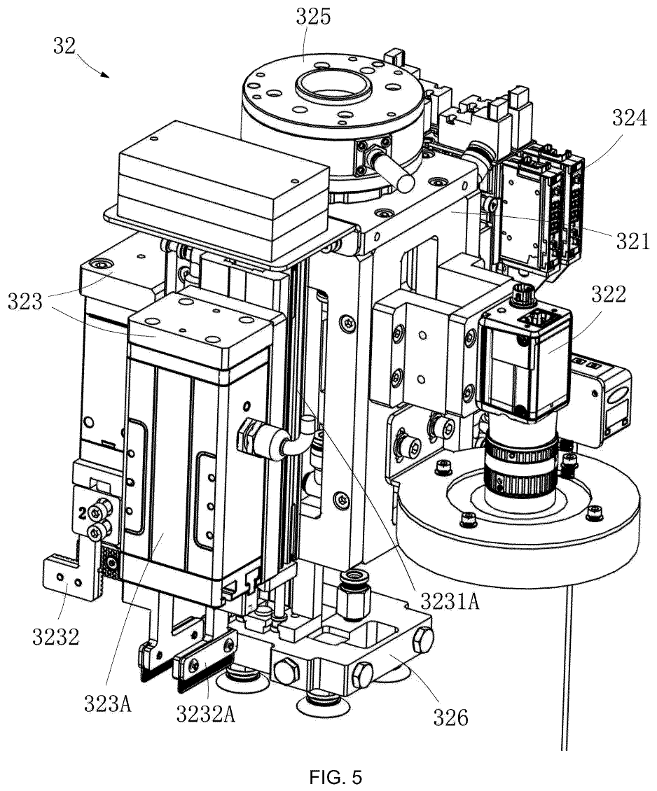

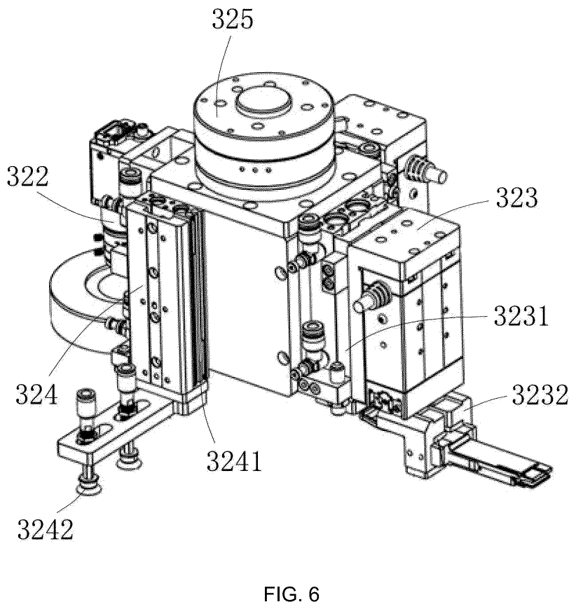

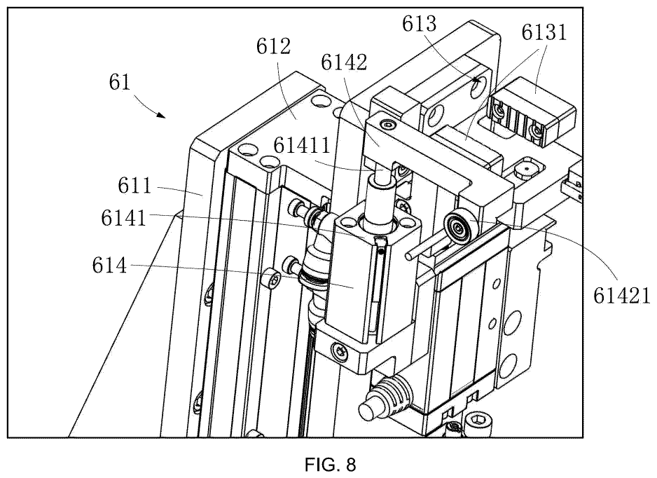

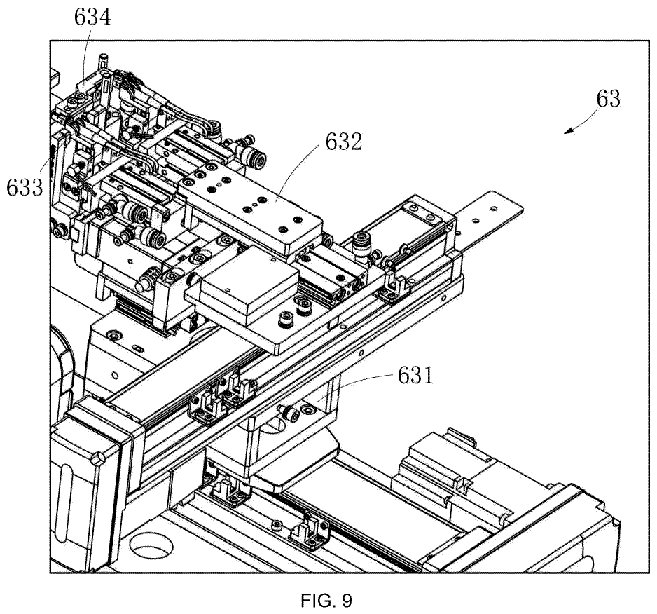

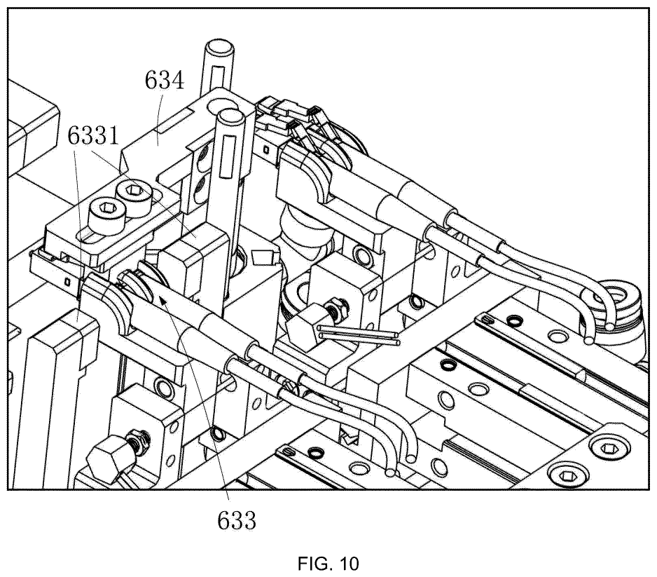

The present invention provides an automated interleaved optical module testing method which interleavedly executes the testing processes of at least two optical modules to improve testing efficiency, and the testing processes can be automated by machines, so as to reduce errors and labor costs associated with manual operation. Referring specifically to FIGS. 1 to 10, the optical module testing progress during testing performed according to the automated interleaved optical module testing method, the step-by-step workflow of the automated interleaved optical module testing method, and the optical module testing platform for executing the automated interleaved optical module testing method are respectively illustrated.

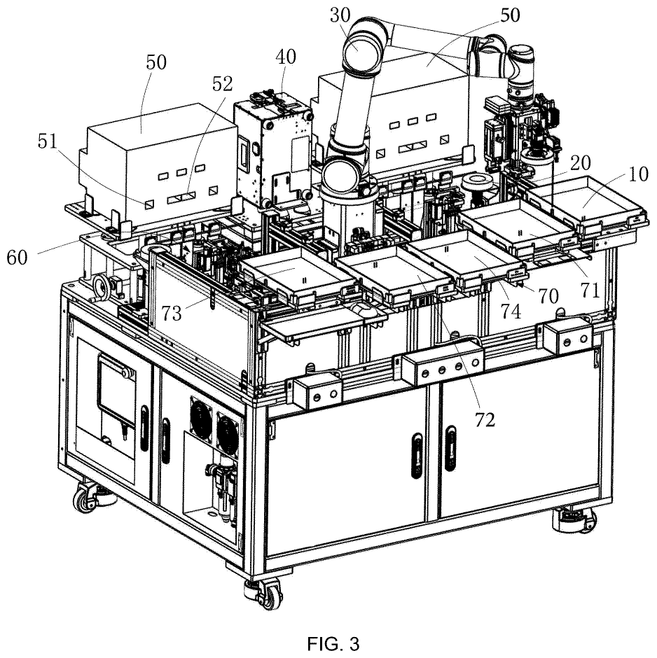

Specifically, referring to FIGS. 2 and 3, the automated interleaved optical module testing method comprises the following steps:
(A) Pick up a first optical module by a robotic arm 30;
(B) Place the first optical module on an end-face inspection instrument 40 by the robotic arm 30, and perform an end-face inspection on the first optical module by the end-face inspection instrument 40;
(C) Pull out a second optical module that has completed the test from a testing instrument 50 by the robotic arm 30, place the second optical module in a fiber optic plug-in station 60, and pick up the second optical module after a fiber optic connector on the second optical module is pulled out.
(D) Place the first optical module in the fiber optic plug-in station 60 by the robotic arm 30, and plug the first optical module into the testing instrument 50 after the fiber optic connector is plugged into the first optical module;
(E) Place the second optical module in an unloading area 70 by the robotic arm 30, and return to the step (A).

Referring to FIG. 1, at time t1, the robotic arm 30 picks up the first optical module A, and the first optical module A begins to enter the testing phase. At this time, the second optical module A-N, which has entered the testing phase before the first optical module A, is still in the testing phase and has not yet finished testing. The automated interleaved optical module testing method executes the steps A and B while the second optical module A-N is still in the testing phase, and executes the testing process of the first optical module A, thereby realizing the time superposition of the testing processes of the first optical module A and the second optical module A-N. In this way, the testing of the third optical module A+1 is started while the first optical module A is still in the testing phase, and the testing of optical modules is interleaved to shorten the overall testing time.

It is understood that, in the above description and FIG. 1, the second optical module A-N represents the first N optical modules that start testing before the first optical module A, wherein N is a positive integer, and the third optical module A+1 represents the first optical module that starts testing after the first optical module A. Furthermore, it is understood that in the description of the present invention, the terms of the first optical module A, the second optical module A-N, and the third optical module A+1 are only used for ease of understanding as to indicate that each optical module enters testing at different times, and do not constitute a limitation on the type of optical module. The first optical module A, the second optical module A-N, and the third optical module A+1 can be different types/models of optical modules, or they can be the same type of optical module, the present invention does not impose any limitations on this.

In other words, during the time period from t1 to t2, the automated interleaved optical module testing method interleaves the testing processes of at least two optical modules. That is, the start of the testing process of the next optical module (such as the third optical module N+1) does not need to wait for the end of the testing process of the previous optical module (such as the first optical module A). At the same time, the testing processes of at least two optical modules can be carried out in parallel, so that it is beneficial to improve testing efficiency.

Specifically, referring to FIG. 1, during the time period from t1 to t2, the optical module testing platform can perform tests on at least two optical modules, and one testing station can simultaneously execute the testing process of at least two optical modules, so as to effectively improve the testing throughput of the optical module testing platform.

Furthermore, in the step (A), after the robotic arm 30 picks up the first optical module, it moves the first optical module to the barcode scanning station 20. After the barcode scanning station 20 identifies the first optical module, the step (B) is executed. Based on the identification of the first optical module by the barcode scanning station 20, the identity of each optical module is determined, which facilitates the tracking, management and data recording of the optical modules, and facilitates subsequent analysis and traceability.

It is worth mentioning that in the step (B), if the end-face inspection instrument 40 detects the optical module as qualified, the step (C) is executed; if the end-face inspection instrument 40 detects the optical module as unqualified, the robotic arm 30 moves the first optical module to the unloading area 70 and returns to the step (A). In other words, the automated interleaved optical module testing method can automatically unload unqualified optical modules during the testing process and re-execute the testing process for the next optical module, so as to continuously perform optical module testing without human intervention, ensuring the continuity of the testing progress, while eliminating the human uncertainty caused by human intervention.

In particular, in some embodiments, if the detection result of the optical module by the end-face inspection instrument 40 is unqualified in the step (B), the step (C) can be executed first, and after executing the step (C), execute the step (E) and the first optical module can be moved to the unloading area 70, and then the process can return to the step (A).

It is worth mentioning that, in the step (D), the robotic arm 30 picks up the next optical module to be tested by the testing instrument 50 after picking up the optical module that has finished testing. This improves the transfer efficiency of the robotic arm 30 to optical modules by picking up at least two optical modules with different testing progress at the same time, thereby improving the efficiency of interleaved optical module testing.

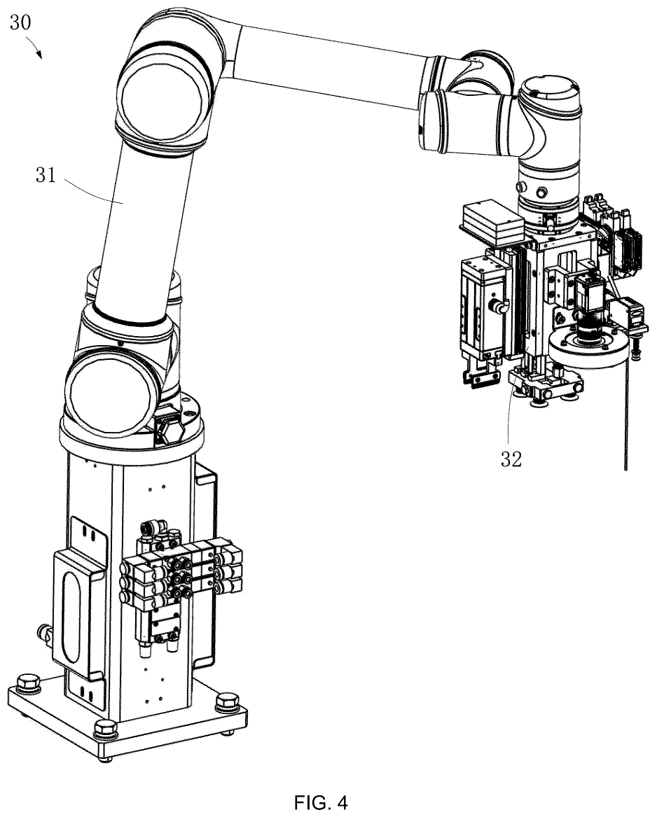

Specifically, referring to FIGS. 4 to 6, the robotic arm 30 comprises a robotic arm body 31 and a robotic hand 32 disposed at the end of the robotic arm body 31. The robotic hand 32 comprises at least two picking elements for picking up optical modules. In the step (D), one picking element of the robotic hand 32 picks up the second optical module, and the other picking element of the robotic hand 32 picks up the first optical module. This enables the simultaneous picking up of at least two optical modules at different testing stages, improving the efficiency of interleaved optical module testing.

It is worth mentioning that each of the picking elements of the robotic hand 32 can be of the same type or different types. In specific applications, the corresponding picking elements can be replaced according to the type of optical module being tested. The present invention does not impose any restrictions on this.

Specifically, in this embodiment of the present invention, the robotic hand 32 comprises two types of picking elements: a suction claw 324 and a gripping claw 323. The suction claw 324 picks up the optical module by suctioning it, while the gripping claw 323 picks up the optical module by clamping it. Different models of the gripping claw 323 can be selected to be suitable for clamping different parts of the optical module. For example, in this example of the present invention, two different models of gripping claw 323 are illustrated. For clarity, one of the gripping claws 323 is designated as the first gripping claw 323A. In this example, the first gripping claw 323A is used to clamp the heat dissipation fins on the top of the optical module to pick up the optical module. The gripping claw 323A, distinct from the first gripping claw 323A, is used to clamp both sides of the optical module to pick up the optical module.

In detail, the robotic hand 32 comprises a base 321 and a vision positioning sensor 322. The base 321 is connected to the end of the robotic arm body 31. The vision positioning sensor 322, the suction claw 324, the gripping claw 323, and the first gripping claw 323A are respectively installed on different sides of the base 321. The vision positioning sensor 322 performs positioning by image recognition, such as determining the relative position between the optical module and the robotic hand 32, the size and angle of the optical module, and the positions of the end-face inspection instrument 40, the testing instrument 50, the fiber optic plug-in station 60, and the unloading area 70, so as to provide a basis for the subsequent precise gripping and movement of the optical module by the robotic hand 32.

The suction claw 324 comprises a first lifting element 3241 and a pair of suction cups 3242. The first lifting element 3241 is mounted on the base 321. The suction cups 3242 are mounted on the first lifting element 3241 and adapted to be driven by the first lifting element 3241 to move up and down with respect to the base 321. The gripping claw 323 comprises a second lifting element 3231 and a gripper 3232. The second lifting element 3231 is mounted on the base 321. The gripper 3232 is mounted on the second lifting element 3231 and adapted to be driven by the second lifting element 3231 to move up and down with respect to the base 321. The gripper 3232 has a pair of gripping fingers. The first gripping claw 323A also comprises the second lifting element and the gripper. The opening and closing range of the two gripping fingers of the gripper 3232A of the first gripping claw 323A is smaller than the opening and closing range of the two gripping fingers of the gripper 3232 of the gripping claw 323A.

In this specific example of the present invention, in the steps A and E, the robotic hand 32 picks up the optical module from the loading area and places it in the unloading area 70 by suctioning or clamping the top of the optical module using the suction claw 324 or the first gripping claw 323A. This facilitates the removal of the optical module from a group of neatly arranged optical modules or the neat arrangement of the optical modules for unloading. In the steps C and D, the robotic hand 32 grips two sides of the optical module using the gripping claw 323 to plug or unplug the optical module from the testing instrument 50. This allows for adaptation to different shapes of optical modules and different processes by using different models or types of the picking elements, thus meeting the needs of automated production.

Furthermore, the robotic hand 32 comprises a six-dimensional force sensor 325 which is disposed between the base 321 and the end of the robotic arm body 31 to measure the force and torque experienced by the robotic hand 32 during operation in real time, thereby achieving high-precision control and feedback, and effectively reducing the probability of damage to the optical module.

It is worth mentioning that the bottom of the base 321 is provided with a suction component 326 which is used to suction the corresponding tray. The tray is used to place the optical modules. That is, the robotic arm 30 can suction the tray onto the optical module testing platform to realize the transportation of the optical module. In actual production, the raw materials are transported to the vicinity of the optical module testing platform by an automated transport vehicle. The robotic arm 30 then suctions the trays containing untested optical modules from the automated transport vehicle onto the optical module testing platform. When the optical modules which have finished the testing fill a tray, the optical module testing platform calls the automated transport vehicle, and the robotic arm 30 moves the tray containing the tested optical modules onto the automated transport vehicle, thus realizing a fully automated testing process.

Referring to FIG. 3, in this embodiment of the present invention, the optical module testing platform is provided with a raw material tray 10 which stores optical modules awaiting testing. In the step (A), the robotic arm 30 picks up the optical modules from the raw material tray 10. The unloading area comprises a finished product tray 71, an end-face inspection NG tray 72, and a test NG tray 73. The end-face inspection NG tray 72 is used to place optical modules that fail the end-face inspection test, the test NG tray 73 is used to place optical modules that fail the test by the testing instrument, and the finished product tray 71 is used to place optical modules that pass the test. In the step (B), if the end-face inspection test result is unqualified, the robotic arm 30 places the optical module in the end-face inspection NG tray 72. In the step (E), based on the test result of the testing instrument 50, the robotic arm 30 places the optical module in the test NG tray 73 or the finished product tray 71. Specifically, when the testing instrument 50 tests the optical module and the result is qualified, the robotic arm 30 places the optical module on the finished product tray 71. When the testing instrument 50 tests the optical module and the result is unqualified, the robotic arm 30 places the optical module on the test NG tray 73. In this way, the optical modules are sorted based on the test results, which facilitates the rapid identification and processing of optical modules with different test results, improves work efficiency, and is conducive to the subsequent analysis of optical modules with unqualified test results. This provides feedback to production and allows for targeted improvement measures, which helps to improve the product quality of the optical modules.

It is worth mentioning that the automated interleaved optical module testing method can automatically sort and unload optical modules that fail different test programs. Optical modules that fail end-face inspection are sent to the end-face inspection NG tray 72, and optical modules that fail the test by the testing instrument 50 are sent to the test NG tray 73. This facilitates subsequent targeted analysis of optical modules that fail different test programs. For example, the reasons for end-face inspection failure can be analyzed for optical modules loaded on the end-face inspection NG tray 72, and the reasons for test failure can be analyzed for optical modules loaded on the test NG tray 73. This helps to take targeted measures to improve the yield rate and product quality of optical modules.

Specifically, the unloading area 70 also comprises a spare tray 74 which is used to serve as the tray when one of the end-face inspection NG pallet 72, the test NG tray 73, and the finished product tray 71 is full of optical modules. For example, when the finished product tray 71 is full of optical modules, the optical module testing platform calls the automated transport vehicle. Before the automated transport vehicle arrives, the robotic arm 30 places the subsequently inspected optical modules into the spare tray 74. The spare tray 74 is then used as the finished product tray 71, thereby enabling continuous testing of optical modules and avoiding the impact of material handling progress on the testing progress.

It is worth mentioning that the raw material tray 10, the finished product tray 71, the end-face inspection NG tray 72, the test NG tray 73, and the spare tray 74 are preferably set to the same specifications and dimensions, which is conducive to unified procurement and management, and can also be used interchangeably in the production process to rationally allocate resources.

It is understood that the positions of the raw material tray 10, the finished product tray 71, the end-face inspection NG tray 72, the test NG tray 73, and the spare tray 74 on the optical module test platform can be adaptively adjusted. The positions and arrangements of the raw material tray 10, the finished product tray 71, the end-face inspection NG tray 72, the test NG tray 73, and the spare tray 74 shown in FIG. 3 do not constitute a limitation of the present invention.

It is worth mentioning that the automated interleaved optical module testing method is suitable for simulating test environments with different temperatures to fully test the performance of the optical module. Specifically, if the end-face inspection is qualified and before performing the step (C), the automated interleaved optical module testing method further comprises the steps of picking up the first optical module by the robotic arm 30 and placing the first optical module in a preheating station, wherein the preheating station facilitates subsequent testing of the performance of the optical module at different temperatures by changing the temperature of the optical module.

Specifically, the testing instrument 50 comprises at least one test port 51 and at least one preheating port 52. The preheating station is located at the preheating port 52. The robotic arm 30 places the first optical module at the preheating station by plugging the first optical module into the preheating port 52. In the steps C and D, the robotic arm 30 removes the optical module from the test port 51 and plugs the optical module into the test port 51. In this embodiment of the invention, the testing instrument 50 has two test ports 51 and two preheating ports 52, and the optical module test platform comprises two testing instruments 50, thereby effectively improving testing efficiency. The automated interleaved optical module testing method can execute the testing process of multiple optical modules at the same time. The two testing instruments 50 on the optical module test platform are located on two sides of the end-face inspection instrument 40 to facilitate the robotic arm 30 picking up the optical module to the designated position.

Specifically, in the step (D), before plugging the first optical module into the testing instrument 50, the robotic arm 30 moves the first optical module to the barcode scanning station 20. After the first optical module is identified at the barcode scanning station 20, it is loaded into the testing instrument 50. That is, the automated interleaved optical module testing method identifies the optical module again during the testing phase when the optical module enters the testing instrument 50, which helps to accurately correspond the test results of the optical module and avoids test result confusion under multiple interleaved optical module testing processes. The optical module testing platform is provided with two barcode scanning stations 20 which are symmetrically arranged on two sides of the robotic arm 30, so that the robotic arm 30 can move the optical module to the corresponding barcode scanning station 20 for identification.

Furthermore, in the step (D), the fiber optic plug-in station 60 cleans the fiber optic connector before plugging it into the first optical module to remove any dust, impurities, or other contaminants that may be present in the fiber optic connector, thereby preventing contaminants from affecting test results and damaging the optical module.

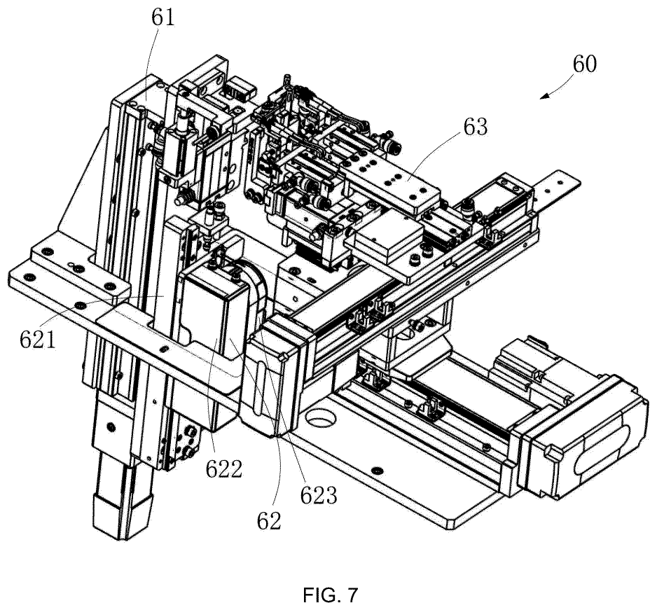

Specifically, referring to FIGS. 7 to 10, the fiber optic plug-in station 60 comprises an optical module mounting base 61, a cleaning unit 62, and a fiber optic plug-in socket 63. The optical module mounting base 61 and the fiber optic plug-in socket 63 are arranged along the plugging and unplugging direction of the fiber optic connector. The optical module mounting base 61 is vertically movable, and the fiber optic plug-in socket 63 is movable along the plugging and unplugging direction of the fiber optic connector. The cleaning unit 62 is vertically movable between the optical module mounting base 61 and the fiber optic plug-in socket 63. The robotic arm 30 is used to place the optical module onto the optical module mounting base 61. The optical module is placed in the fiber optic plug-in station 60. Before the fiber optic connector is plugged into the optical module, the cleaning unit 62 rises between the optical module mounting base 61 and the fiber optic plugging and unplugging base 63. The fiber optic plugging and unplugging base 63 moves the fiber optic connector toward the cleaning unit so that the fiber optic connector contacts the cleaning unit 62 and is cleaned. After cleaning, the fiber optic plugging and unplugging base 63 moves away from the cleaning unit 62, and the cleaning unit 62 descends to avoid blocking the fiber optic plugging and unplugging base 63 from plugging the fiber optic connector into the optical module placed on the optical module mounting base 61.

It is worth mentioning that in the steps C and D, after the robotic arm 30 places the optical module on the optical module mounting base 61, and before the fiber optic plugging and unplugging base 63 plugs the fiber optic connector or pulls it out, the optical module mounting base 61 limits the optical module to ensure the stability of the fiber optic connector during loading and removal, and helps to avoid damage to the optical module when loading or removing the fiber optic connector.

Specifically, the optical module mounting base 61 comprises a lifting component 611, a lifting seat 612, a clamping seat 613, and a pressing part 614. The lifting seat 612 is mounted on the lifting component 611 and is adapted to be raised or lowered by the lifting component 611. The clamping seat 613 is disposed on the lifting seat 612 and comprises two opposing retaining walls 6131. The robotic arm 30 places the optical module in the fiber optic plug-in station 60 with the optical module positioned between the two retaining walls 6131. The distance between the two retaining walls 6131 is adjustable for clamping the optical module. The pressing part 614 comprises a rotary lifting seat 6141 and a pressing rod 6142. The bottom of the rotary lifting seat 6141 is mounted on the lifting seat 612. The top of the rotary lifting seat 6141 comprises an upwardly extending rotary telescopic rod 61411. The pressing rod 6142 is connected to the rotary telescopic rod 61411 and has an extension direction perpendicular to the axial direction of the rotary telescopic rod 61411. When the robotic arm 30 places the optical module between the two retaining walls 6131, the two retaining walls 6131 move with respect to each other to bring the optical module closer together for clamping the optical module between the two retaining walls 6131. The rotary telescopic rod 61411 rises and rotates to move the pressing rod 6142 above the optical module and retracts downward so that the pressing rod 6142 presses against the optical module, thereby retaining and fixing the optical module.

One end of the pressing rod 6142 is mounted to the rotary telescopic rod 61411 and comprises a pressing arm extending from that end. The pressing arm is extended linearly from that end of the pressing rod 6142 in a direction perpendicular to the axial direction of the rotary telescopic rod 61411, then is bent and continues to extend in a direction perpendicular to the axial direction of the rotary telescopic rod 61411 to form an L-shape. A pressing block 61421 is mounted on the end of the pressing rod 6142 opposite to the end mounted on the rotary telescopic rod 61411. The pressing rod 6142 presses the optical module with the pressing block 61421 abutting against the optical module. The pressing block 61421 can form a pressing buffer for the optical module to avoid damage to the optical module. The pressing block 61421 is detachably installed on the pressing rod 6142, which can adapt to different sizes of optical modules by replacing the pressing block 61421, and facilitate maintenance work and reduce maintenance costs by removing and replacing the pressing block 61421.

Further, the fiber optic plug-in socket 63 comprises a longitudinal moving base 631, a transverse moving base 632, a transverse clamping component 633, and a lifting unlocking component 634. The transverse moving base 632 is mounted on the longitudinal moving base 631 and moves along the plugging and unplugging direction of the fiber optic connector following the longitudinal moving base 631. The transverse clamping component 633 is mounted on the transverse moving base 632 and comprises two clamping arms 6331 facing each other in the transverse direction. The distance between the two clamping arms 6331 is adjustable to accommodate clamping the fiber optic connector. The lifting unlocking component 634 is vertically movably mounted on the transverse moving base 632 and is used to press down the fiber optic connector clamped between the two clamping arms 6331 so that the fiber optic connector can be plugged into the optical module.

Specifically, when plugging the fiber optic connector into the optical module, the lifting unlocking component 634 presses down on the fiber optic connector clamped between the two clamping arms 6331. The longitudinal moving seat 631 drives the transverse moving seat 632 forward to plug the fiber optic connector into the optical module. The two clamping arms 6331 move away from each other to release the fiber optic connector. The longitudinal moving seat 631 drives the transverse moving seat 632 backward to complete the plugging of the fiber optic connector. When removing the fiber optic connector from the optical module, after the optical module is fixed by the optical module mounting base 61, the longitudinal moving seat 631 drives the transverse moving seat 632 forward. The two clamping arms 6331 move closer to each other to clamp the fiber optic connector plugged into the optical module. The lifting unlocking component 634 presses down to unlock the fiber optic connector. The longitudinal moving seat 631 drives the transverse moving seat 632 backward to remove the fiber optic connector. This automated load and removal of the fiber optic connector allows for controllable control of the load and removal force, effectively avoiding the risk of damage to the optical module caused by manual load and removal.

In the description of this specification, the references to terms such as “one embodiment”, “some embodiments”, “example”, “specific example”, or “some examples”, etc., refer to specific features, structures, materials, or characteristics described in connection with that embodiment or example, which are comprised in at least one embodiment or example of the present invention. In this specification, the illustrative expressions of the above terms do not necessarily refer to the same embodiment or example. Furthermore, the specific features, structures, materials, or characteristics described may be combined in any suitable manner in one or more embodiments or examples. Moreover, without contradiction, those skilled in the art can combine and integrate the different embodiments or examples described in this specification, as well as the features of different embodiments or examples.

Those skilled in the art should understand that the embodiments of the present invention described above and shown in the accompanying drawings are merely examples and do not limit the present invention. The objectives of the present invention have been fully and effectively achieved. The functions and structural principles of the present invention have been demonstrated and explained in the embodiments, and any variations or modifications may be made to the implementation of the present invention without departing from the stated principles.

What is claimed is:

1. 1. An automated interleaved optical module testing method, comprising:
(A) picking up a first optical module by a robotic arm;
(B) placing the first optical module on an end-face inspection instrument by the robotic arm, and performing an end-face inspection on the first optical module by the end-face inspection instrument;
(C) pulling out a second optical module that has completed the test from a testing instrument by the robotic arm, placing the second optical module in a fiber optic plug-in station, and picking up the second optical module after a fiber optic connector on the second optical module is pulled out;
(D) placing the first optical module in the fiber optic plug-in station by the robotic arm, and plugging the first optical module into the testing instrument after the fiber optic connector is plugged into the first optical module;
(E) placing the second optical module in an unloading area by the robotic arm, and returning to the step (A).

2. The automated interleaved optical module testing method according to claim 1, wherein in the step (A), after the robotic arm picks up the first optical module, the first optical module is moved to a barcode scanning station, and after the first optical module is identified at the barcode scanning station, the step (B) is executed.

3. The automated interleaved optical module testing method according to claim 2, wherein in the step (B), if the test result is qualified, the step (C) is executed; if the test result is unqualified, the robotic arm moves the first optical module to the unloading area and returns to the step (A).

4. The automated interleaved optical module testing method according to claim 2, wherein if the End-face inspection is qualified, the robotic arm picks up the first optical module, and the step (C) is executed while the robotic arm is picking up the first optical module.

5. The automated interleaved optical module testing method according to claim 2, wherein if the end-face inspection is qualified and before performing the step (D), the robotic arm picks up the first optical module and places the first optical module in a preheating station.

6. The automated interleaved optical module testing method according to claim 2, wherein in the step (D), the fiber optic plug-in station cleans the fiber optic connector before plugging the fiber optic connector into the first optical module.

7. The automated interleaved optical module testing method according to claim 6, wherein in the step (D), before plugging the first optical module into the testing instrument, the robotic arm moves the first optical module to the barcode scanning station, and after the first optical module is identified at the barcode scanning station, the first optical module is plugged into the testing instrument.

8. The automated interleaved optical module testing method according to claim 6, wherein in the step (C), before the fiber optic connector is pulled out of the second optical module, the fiber optic plug-in station retains and fixes the second optical module.

9. The automated interleaved optical module testing method according to claim 8, wherein in the step (D), before inserting the fiber optic connector into the first optical module, the fiber optic plug-in station limits and fixes the first optical module.

10. The automated interleaved optical module testing method according to claim 9, wherein in the step (E), the robotic arm places the second optical module in different areas of the unloading area based on the test results of the second optical module.

11. The automated interleaved optical module testing method according to claim 1, wherein the robotic arm comprises a robotic arm body and a robotic hand disposed at an end of the robotic arm body, wherein the robotic hand comprises at least two picking elements for picking up the optical modules, wherein in the step (D), one of the picking elements of the robotic hand picks up the second optical module, and the other picking member of the robotic hand picks up the first optical module.

12. The automated interleaved optical module testing method according to claim 11, wherein the robotic hand comprises a base and a vision positioning sensor, wherein the base is connected to the end of the robotic arm body, and the vision positioning sensor and each of the picking elements are respectively mounted on different sides of the base.

13. The automated interleaved optical module testing method according to claim 12, wherein the robotic arm comprises two different types of picking elements, one of which is a suction claw and the other is a gripping claw, wherein the suction claw comprises a first lifting element and a pair of suction cups, wherein the first lifting element is mounted on the base, wherein each suction cup is mounted on the first lifting element and adapted to be driven by the first lifting element to move up and down with respect to the base, wherein the gripping claw comprises a second lifting element and a gripper, wherein the second lifting element is mounted on the base, the gripper is mounted on the second lifting element and adapted to be driven by the second lifting element to move up and down with respect to the base, and the gripper comprises a pair of gripping fingers.

14. The automated interleaved optical module testing method according to claim 13, wherein the robotic arm comprises two said gripping claws, and the two gripping claws are of the same type.

15. The automated interleaved optical module testing method according to claim 13, wherein the robotic arm comprises two said gripping claws, wherein the opening and closing range of the two gripping fingers of one gripping claw is smaller than the opening and closing range of the two gripping fingers of the other gripping claw.

16. The automated interleaved optical module testing method according to claim 15, wherein the robotic arm comprises a six-dimensional force sensor, wherein the six-dimensional force sensor is disposed between the base and the end of the robotic arm body, wherein a bottom of the base is provided with a suction component for suctioning a corresponding tray which is arranged for placing the optical module.

17. The automated insertion and removal optical module testing method according to claim 6, wherein the fiber optic plug-in station comprises an optical module mounting base, a cleaning unit, and a fiber optic plug-in socket, wherein the optical module mounting base and the fiber optic plug-in socket are arranged along a plugging direction of the fiber optic connector, the optical module mounting base is vertically movable, the fiber optic plug-in socket is movable along the plugging direction of the fiber optic connector, the cleaning unit is vertically movable between the optical module mounting base and the fiber optic plug-in socket, wherein the robotic arm places the optical module in the fiber optic plug-in station with the optical module mounted on the optical module mounting base, wherein the cleaning unit rises between the optical module mounting base and the fiber optic plug-in socket before the fiber optic connector is plugged into the optical module, the fiber optic plug-in socket moves the fiber optic connector toward the cleaning unit so that the fiber optic connector contacts the cleaning unit and is cleaned, and after cleaning, the fiber optic plug-in socket moves away from the cleaning unit, and the cleaning unit descends.

18. The automated interleaved optical module testing method according to claim 17, wherein the optical module mounting base comprises a lifting component, a lifting seat, a clamping seat, and a pressing part, wherein the lifting seat is installed on the lifting component and is adapted to be driven to rise or fall by the lifting component, wherein the clamping seat is disposed on the lifting seat and comprises two opposing retaining walls, the robotic arm places the optical module in the fiber optic plug-in station with the optical module placed between the two retaining walls, the distance between the two retaining walls is adjustable for clamping the optical module, wherein the pressing part comprises a rotary lifting seat and a pressing rod, wherein a bottom of the rotary lifting seat is installed on the lifting seat, a top of the rotary lifting seat comprises an upwardly extending rotary telescopic rod, wherein the pressing rod is connected to the rotary telescopic rod and has an extension direction perpendicular to an axial direction of the rotary telescopic rod.

19. The automated insertion and removal optical module testing method according to claim 18, wherein the fiber optic plug-in socket comprises a longitudinal moving base, a transverse moving base, a transverse clamping component, and a lifting unlocking component, wherein the transverse moving base is mounted on the longitudinal moving base and moves along the plugging direction of the fiber optic connector following the longitudinal moving base, wherein the transverse clamping component is mounted on the transverse moving base and comprises two clamping arms opposite each other in the transverse direction, a distance between the two clamping arms is adjustable to clamp the fiber optic connector, wherein the lifting unlocking component is vertically movably mounted on the transverse moving base and is used to press down the fiber optic connector clamped between the two clamping arms, so as to allow the fiber optic connector to be plugged into the optical module.

20. The automated interleaved optical module testing method according to claim 9, wherein the unloading area comprises an end-face inspection NG tray, a test NG tray, and a finished product tray, wherein the end-face inspection NG tray is used to place optical modules that fail the end-face inspection, the test NG tray is used to place optical modules that fail the test by the testing instrument, and the finished product tray is used to place optical modules that pass the test, wherein in the step (B), if the end-face inspection result is unqualified, the robotic arm places the optical module in the end-face inspection NG tray, wherein in the step (E), based on the test result of the testing instrument, the robotic arm places the optical module in the test NG tray or the finished product tray, wherein in the step (A), the robotic arm picks up the optical module from a raw material tray, wherein the raw material tray is used to store the optical module waiting to be tested, wherein the unloading area further comprises a spare tray, wherein the spare tray is used to be activated as such when one of the end-face inspection NG tray, the test NG tray, and the finished product tray is full of the optical modules.
